(19) United States
(12) Patent Application Publication
(10) Pub. No.: US 2026/0033931 A1
(43) Pub. Date: Feb. 5, 2026

(54) ORAL CLEANING DEVICE, CONTROL METHOD, COMPUTING DEVICE, AND STORAGE MEDIUM

(71) Applicant: Shenzhen Soocas Technology Co., Ltd., Shenzhen (CN)

(72) Inventors: Yingjun WANG, Shenzhen (CN); Zhikun YIN, Shenzhen (CN); Zhoujian LI, Shenzhen (CN); Fandi MENG, Shenzhen (CN)

(73) Assignee: Shenzhen Soocas Technology Co., Ltd., Shenzhen (CN)

(21) Appl. No.: 18/991,574

(22) Filed: Dec. 22, 2024

Related U.S. Application Data
(63) Continuation of application No. PCT/CN2024/124288, filed on Oct. 11, 2024.

(30) Foreign Application Priority Data
Jul. 30, 2024 (CN) 202411040599.1

(51) Int. Cl. A61C 17/22; A61C 1/00

(52) U.S. Cl. CPC A61C 17/221; A61C 1/003

(57) ABSTRACT

Embodiments of the specification provide an oral cleaning device, a control method, a computing device, and a storage medium; the oral cleaning device includes a grip portion, a driving unit at least partially accommodated in the grip portion, and a cleaning head connected with the driving unit; wherein the grip portion is configured to acquire a starting or adjusting signal and send a target driving signal to the driving unit, the target driving signal carrying a random cleaning angle; the driving unit is configured to, in response to the target driving signal, drive the cleaning head to perform a cleaning motion according to the random cleaning angle; the cleaning head is configured to contact a to-be-cleaned oral region and perform an oral cleaning operation on the to-be-cleaned oral region based on the driving of the driving unit.

### CROSS-REFERENCE TO RELATED APPLICATION

This application is a continuation of International Application No. PCT/CN2024/124288, filed on Oct. 11, 2024, which claims priority to Chinese Patent Application No. 202411040599.1 titled “ORAL CLEANING DEVICE, CONTROL METHOD, COMPUTING DEVICE, AND STORAGE MEDIUM” filed on Jul. 30, 2024, the entire contents of which are incorporated herein by reference.

### TECHNICAL FIELD

Embodiments of the specification relate to the field of oral cleaning technologies, and in particular, to an oral cleaning device; one or more embodiments of the specification also relate to a control method, a computing device, a computer-readable storage medium, and a computer program product.

### BACKGROUND

With the continuous development of science and technology and the continuous improvement of the living standard of residents, the public attaches importance to oral care, and therefore, various types of oral cleaning tools emerge on the market to meet demands of the public on the oral care.

In the prior art, an oral cleaning tool, such as an electric toothbrush, usually only performs high-frequency reciprocating vibrations according to a preset frequency, the single cleaning mode neglects different conditions of to-be-nursed oral cavities of different users, and therefore, the oral cleaning tool cannot flexibly adapt to the actual conditions of the different to-be-nursed oral cavities, and cannot meet personalized oral care demands of the users.

### SUMMARY

In view of this, embodiments of the specification provide an oral cleaning device. One or more embodiments of the specification also relate to a control method, a computing device, a computer-readable storage medium, and a computer program product, so as to solve the technical defect of the prior art that an oral cleaning tool cannot flexibly adapt to actual conditions of different to-be-nursed oral cavities.

According to a first aspect of the embodiments of the specification, there is provided an oral cleaning device, including a grip portion, a driving unit at least partially accommodated in the grip portion, and a cleaning head connected with the driving unit;

wherein the grip portion is configured to acquire a starting or adjusting signal and send a target driving signal to the driving unit, the target driving signal carrying a random cleaning angle;

the driving unit is configured to, in response to the target driving signal, drive the cleaning head to perform a cleaning motion according to the random cleaning angle;

the cleaning head is configured to contact a to-be-cleaned oral region and perform an oral cleaning operation on the to-be-cleaned oral region based on the driving of the driving unit.

According to a second aspect of the embodiments of the specification, there is provided a control method applied to a control unit in an oral cleaning device, the oral cleaning device including a grip portion, a driving unit at least partially accommodated in the grip portion, and a cleaning head connected with the driving unit, the control method including:
determining a target driving signal in response to an acquired starting or adjusting signal, the target driving signal carrying a random cleaning angle; and
sending the target driving signal to the driving unit, such that the driving unit drives the cleaning head to perform a cleaning motion according to the random cleaning angle in response to the target driving signal.

Further, the determining a target driving signal in response to an acquired starting or adjusting signal further includes:
determining a reference position of a driving shaft in the driving unit in response to the acquired starting or adjusting signal; and
generating the target driving signal based on the reference position and the random cleaning angle, the random cleaning angle being generated by the control unit based on a random angle generation algorithm.

According to a third aspect of the embodiments of the specification, there is provided a computing device, including:
a memory and a processor;

wherein the memory is configured to store a computer program/instruction, the processor is configured to execute the computer program/instruction, and the computer program/instruction, when executed by the processor, implements the steps of the above-described control method.

According to a fourth aspect of the embodiments of the specification, there is provided a computer-readable storage medium storing a computer program/instruction, the computer program/instruction, when executed by a processor, implementing the steps of the above-described control method.

According to a fifth aspect of the embodiments of the specification, there is provided a computer program product including a computer program/instruction, the computer program/instruction, when executed by a processor, implementing the steps of the above-described control method.

One or more embodiments of the specification provide the oral cleaning device including the grip portion, the driving unit at least partially accommodated in the grip portion, and the cleaning head connected with the driving unit; the grip portion is configured to acquire the starting or adjusting signal and send the target driving signal carrying the random cleaning angle to the driving unit, the driving unit is configured to, in response to the target driving signal, drive the cleaning head to perform the cleaning motion according to the random cleaning angle, and the cleaning head is configured to contact the to-be-cleaned oral region and perform the oral cleaning operation on the to-be-cleaned oral region based on the driving of the driving unit, such that oral cleaning is flexibly performed based on the random cleaning angle, thereby adapting to the actual conditions of different to-be-nursed oral cavities, and meeting personalized oral care demands of users.

### BRIEF DESCRIPTION OF THE DRAWINGS

FIG. 1 is a schematic structural diagram of an oral cleaning device according to an embodiment of the specification;

FIG. 2 is a flow chart of a control method according to an embodiment of the specification;

FIG. 3 is a flow chart of another control method according to an embodiment of the specification;

FIG. 4 is a flow chart of a process of a control method according to an embodiment of the specification.

The drawings include the following reference numerals:

cleaning head 102, grip portion 104, and user interaction control 106.

### DETAILED DESCRIPTION

In the prior art, an oral cleaning tool, such as an electric toothbrush, usually only performs high-frequency reciprocating vibrations according to a preset frequency, and the single cleaning mode neglects different conditions of to-be-nursed oral cavities of different users; for example, for the electric toothbrush on the market, a brush head is driven to generate high-frequency vibrations through quick vibrations of a motor, such that toothpaste is instantly decomposed into fine foam to deeply clean slits between teeth. However, the existing electric toothbrush can only realize the high-frequency reciprocating vibrations according to the preset frequency, but the to-be-cleaned oral cavities of different users have different conditions, different regions of the same user have different tooth conditions, and therefore, the existing electric toothbrush cannot meet personalized cleaning requirements of the users. Furthermore, the electric toothbrush can greatly sweep while vibrating to improve efficient cleaning of the oral cavity to a certain extent, but the solution still has the problem that the teeth are prone to hit and injury, thus influencing a comfort level of the user; the electric toothbrush in the prior art can only sweep according to a preset track, but the to-be-cleaned oral cavities of different users have different conditions, different regions of the same user have different tooth conditions, and therefore, the existing electric toothbrush cannot meet the personalized cleaning requirements of the users. That is, the electric toothbrush has major drawbacks that, firstly, the existing electric toothbrush can only realize the high-frequency reciprocating vibrations according to the preset frequency, and cannot provide more flexible and variable vibrations to adapt to different conditions of the to-be-cleaned oral cavities; secondly, the electric toothbrush can only sweep according to the preset track, and cannot provide more flexible and variable sweeps to adapt to different conditions of the to-be-cleaned oral cavities.

Based on this, in the specification, an oral cleaning device is provided; one or more embodiments of the specification also relate to a control method, a computing device, a computer-readable storage medium, and a computer program product, which are described in detail in the following embodiments one by one.

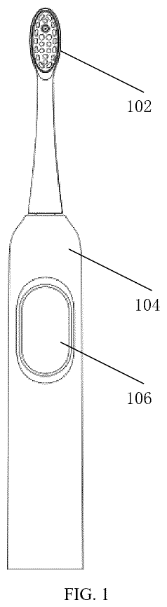

As shown in FIG. 1, FIG. 1 is a schematic structural diagram of an oral cleaning device according to an embodiment of the specification, and one or more embodiments of the specification provide an oral cleaning device, including:
a grip portion 104, a driving unit at least partially accommodated in the grip portion 104, and a cleaning head 102 connected with the driving unit;
wherein the grip portion 104 is configured to acquire a starting or adjusting signal and send a target driving signal to the driving unit, the target driving signal carrying a random cleaning angle;
the driving unit is configured to, in response to the target driving signal, drive the cleaning head 102 to perform a cleaning motion according to the random cleaning angle;
the cleaning head 102 is configured to contact a to-be-cleaned oral region and perform an oral cleaning operation on the to-be-cleaned oral region based on the driving of the driving unit.

The oral cleaning device can be understood as a device for realizing an oral cleaning operation; for example, the oral cleaning device can be an electric toothbrush for realizing a tooth brushing operation, an oral irrigator for realizing tooth irrigation and tooth brushing operations, an irrigation-brushing all-in-one machine for realizing tooth irrigation and tooth brushing operations, or the like.

The grip portion 104 may be understood as a component of the oral cleaning device configured to facilitate gripping by the user; for example, the grip portion 104 may be a handle component.

The driving unit may be understood as a unit in the oral cleaning device for driving the cleaning head 102 to perform the oral cleaning operation; for example, the driving unit may be a motor component, or the like. The driving unit may include a driving shaft for receiving the detachable cleaning head 102 and a motor arrangement for rotating the driving shaft and/or imparting a vibratory motion to the driving shaft.

The cleaning head 102 can be understood as a component configured to contact the to-be-cleaned oral region and capable of cleaning the to-be-cleaned oral region, and the cleaning head 102 is detachably mounted at one end of the oral cleaning device; in one or more embodiments of the specification, the oral cleaning device is an electric toothbrush, and the cleaning head 102 is a cleaning brush head; based on mutual cooperation between the electric toothbrush and the cleaning brush head arranged on the electric toothbrush, the tooth brushing operation can be performed on the to-be-cleaned oral region of the user, thus meeting an oral cleaning requirement of the user.

The starting or adjusting signal may be an instruction sent by a device control terminal, such as a signal sent to the oral cleaning device by the device control terminal, such as a mobile terminal (a mobile phone, a remote controller, and a tablet computer), a fixed terminal (a server, and cloud), or the like; or the starting or adjusting signal may be a signal sent to the oral cleaning device by the user via a user interaction control 106 provided by the oral cleaning device, such as a signal sent by the user via a key operation, an instruction input operation, or the like.

The acquisition of the starting or adjusting signal may be passive receiving of a starting or adjusting instruction by the oral cleaning device, or may be a result obtained by performing detection and judgment by the oral cleaning device according to a current situation; for example, the oral cleaning device is automatically turned on after sensing a pressure and a temperature generated after the user holds the oral cleaning device. The starting or adjusting signal may be an instruction for starting the oral cleaning device or an instruction for adjusting the oral cleaning device to perform a specific operation, for example, adjusting a cleaning mode, cleaning duration, a vibration frequency, a swing amplitude, a swing speed, or the like, of the oral cleaning device.

The target driving signal may be understood as a signal for controlling the driving unit to perform a preset running program, for example, a signal for controlling the motor to rotate according to a random cleaning angle or apply vibrations to the cleaning head 102.

The random cleaning angle may be understood as a randomly generated angle for controlling the cleaning head 102 to perform oral cleaning, and may be of one or more types; in one or more embodiments of the specification, the random cleaning angle includes a first random cleaning angle, a first pseudo-random cleaning angle, a second random cleaning angle, and a second pseudo-random cleaning angle; the first random cleaning angle or the first pseudo-random cleaning angle is less than 10 degrees, preferably less than 8 degrees, preferably less than 6 degrees, and preferably less than 5 degrees; the second random cleaning angle or the second pseudo-random cleaning angle is greater than or equal to 10 degrees and less than or equal to 60 degrees; during the oral cleaning process of the oral cleaning device of the specification, a motor shaft may be controlled to randomly swing by one random cleaning angle (generated by a random algorithm) leftwards or rightwards at a high speed in a certain small angle range (for example, 0 to 10 degrees) relative to a reference position thereof, so as to realize vibrations with a changeable frequency; and/or the motor shaft is controlled to generate a larger-angle swing (for example, greater than 10 degrees and less than 60 degrees) through a second random angle while keeping the vibration, so as to realize random sweeping at a settable speed, such that flexible oral cleaning is realized, thereby adapting to actual conditions of different to-be-nursed oral cavities; the vibration is kept during the sweeping, which integrates the sweeping and the vibration, thus providing better clean experience for the user. Through the sweeping flexible and changeable in a certain range, or the vibration flexible and changeable in a certain range, or the sweeping flexible and changeable in a certain range plus the vibration flexible and changeable in a certain range, a sanitary dead angle is cleaned through the random angle, thus avoiding setting high torque, improving a cleaning comfort level, and meanwhile avoiding an injury of excessively large torsion to the teeth. The vibration frequency of the motor during working is randomly variable, and the working frequency of the motor is prevented from being close to an inherent frequency of the motor, which can effectively avoid a resonance of the motor to guarantee a normal motion of the motor.

It should be noted that the first random cleaning angle, the first pseudo-random cleaning angle, the second random cleaning angle, and the second pseudo-random cleaning angle may be set according to an actual application scenario, and are not specifically limited in the specification.

The cleaning motion may be understood as a cleaning motion performed by the cleaning head 102 on the to-be-cleaned oral region, and as the cleaning motion, the cleaning head 102 performs a vibration operation according to the random cleaning angle and/or the cleaning head 102 performs a sweeping operation according to the random cleaning angle; in one or more embodiments of the specification, as the vibration operation, the cleaning head 102 is driven to vibrate according to a preset vibration frequency range which is greater than or equal to 100 Hz and less than or equal to 700 Hz; as the sweeping operation, the cleaning head 102 is driven to sweep according to a preset sweeping frequency range which is greater than or equal to 20 degrees per second and less than or equal to 2,000 degrees per second. During the oral cleaning process of the oral cleaning device of the specification, the vibration flexible and changeable in a certain range is provided to adapt to different conditions of the to-be-cleaned oral cavities, the set vibration range ensures a basic cleaning force, and on the basis, more different parts can be cleaned using the randomly variable vibration angle (for example, the motor of the electric toothbrush vibrates at a high frequency, a part of the user required to be cleaned may not be cleaned in a single randomly variable vibration, but the vibration frequency is 30,000 to 40,000 per minute, and more different parts can be cleaned under multiple iterations), such that a cleaning effect is better; in addition, the sweeping flexible and changeable in a certain range is provided to adapt to different conditions of the to-be-cleaned oral cavities, and thus, the cleaning effect is better.

In one or more embodiments of the specification, the target driving signal includes a first driving signal and/or a second driving signal;

the first driving signal carries the first random cleaning angle or the first pseudo-random cleaning angle;

the driving unit is further configured to, in response to the first driving signal, drive the cleaning head 102 to perform a first cleaning motion according to the first random cleaning angle or the first pseudo-random cleaning angle;

the second driving signal carries the second random cleaning angle or the second pseudo-random cleaning angle;

the driving unit is further configured to, in response to the second driving signal, drive the cleaning head 102 to perform a second cleaning motion according to the second random cleaning angle or the second pseudo-random cleaning angle.

As the first cleaning motion, the cleaning head 102 is driven to perform the vibration operation according to the first random cleaning angle or the first pseudo-random cleaning angle;

as the second cleaning motion, the cleaning head 102 is driven to perform the sweeping operation according to the second random cleaning angle or the second pseudo-random cleaning angle.

In the above embodiment, the driving unit is controlled by the first driving signal and/or the second driving signal to drive the cleaning head 102 to perform the first cleaning motion and/or the second cleaning motion, such that the oral cleaning device can provide multiple cleaning modes in the oral cleaning process, thus avoiding the problem of a single cleaning mode and meeting diversified cleaning requirements of the user.

In one or more embodiments of the specification, the first driving signal carries a first reference range;

the driving unit is further configured to, in response to the first driving signal, drive the cleaning head 102 to perform the first cleaning motion according to the first random cleaning angle or the first pseudo-random cleaning angle within the first reference range.

The first reference range may be understood as a range corresponding to the first cleaning motion in an execution process, and the first reference range may be set according to an actual application scenario; for example, the first reference range may be understood as a range of 0 to 10 degrees relative to the reference position of the driving shaft, or a range of 0 to 5 degrees relative to the reference position of the driving shaft; the first cleaning motion (i.e., the vibration operation) is required to be performed within the range of 0 to 10 degrees or within the range of 0 to 5 degrees.

For example, the motor shaft (i.e., the driving shaft) of the electric toothbrush is controlled to randomly swing by one random angle leftwards or rightwards at a high speed within a range of 0 to 10 degrees (i.e., the first reference range) relative to the reference position thereof, so as to realize a vibration with a changeable frequency; the vibration is a reciprocating rotation motion which takes an axis of the motor shaft as a rotation axis, and the motor shaft swings by one random angle leftwards at the high speed and then immediately swings by one random angle rightwards at the high speed; the random angle includes a reference range (i.e., the first reference range), and if the reference range includes left 5 degrees or right 5 degrees, under control of a random signal, the motor shaft firstly swings leftwards by 5.1 degrees and then swings rightwards by 4.9 degrees; therefore, the vibration flexible and changeable in a certain range is realized to adapt to different conditions of the to-be-cleaned oral cavities, and the set vibration range ensures the basic cleaning force.

In one or more embodiments of the specification, the second driving signal carries a second reference range;

the driving unit is further configured to, in response to the second driving signal, drive the cleaning head 102 to perform the second cleaning motion according to the second random cleaning angle or the second pseudo-random cleaning angle within the second reference range.

The second reference range may be understood as a range corresponding to the second cleaning motion in an execution process, and the second reference range may be set according to an actual application scenario; for example, the second reference range may be understood as a range of 10 to 60 degrees relative to the reference position of the driving shaft, or a range of 15 to 65 degrees relative to the reference position of the driving shaft; the second cleaning motion (i.e., the sweeping operation) is required to be performed within the range of 10 to 60 degrees or within the range of 15 to 65 degrees.

For example, the motor shaft of the electric toothbrush is controlled to generate a larger-angle swing (for example, greater than 10 degrees and less than 60 degrees) through a second random angle while keeping the vibration, the swing is performed within a range of 10 to 60 degrees or within a range of 15 to 65 degrees, and speed-settable random sweeping is realized, such that the electric toothbrush also maintains the vibration during sweeping, thus integrating the sweeping and the vibration.

In one or more embodiments of the specification, the driving unit includes a driving shaft connected with the cleaning head 102;

as the first cleaning motion, the driving shaft is controlled to rotate by the first random cleaning angle or the first pseudo-random cleaning angle in a first direction or a second direction with a first axis as a rotation center line relative to a reference position of the driving shaft, so as to drive the cleaning head 102 to perform a vibration operation.

The driving shaft can be understood as a component for driving the cleaning head 102 to perform the cleaning motion, the cleaning head 102 is detachably mounted on the driving shaft, and in the case where the driving shaft rotates and/or vibrates, the cleaning head 102 can be driven to perform a sweeping operation and/or the vibration operation; for example, the driving shaft may be a motor shaft.

The reference position of the driving shaft may be understood as an initial position of the driving shaft, and the cleaning motion performed by the cleaning head 102 may be performed relative to the reference position; for example, the motor shaft is controlled to swing by a random angle within a certain angle range relative to the reference position thereof.

The first axis can be understood as a center point or a center axis of the first cleaning motion, and during the execution of the first cleaning motion, the driving shaft is controlled to rotate in the first direction or the second direction by the first random cleaning angle or the first pseudo-random cleaning angle with the first axis as the rotation center line, so as to drive the cleaning head 102 to perform the vibration operation.

The first direction and the second direction may be a left-right direction, a front-back direction, an up-down direction, or the like.

For example, after the electric toothbrush is started, the reference position of the motor shaft set in a factory is required to be read, and the motor shaft is controlled to randomly swing by a random angle leftwards or rightwards at a high speed relative to the reference position thereof within a certain small angle range, so as to realize a vibration with a changeable frequency; the vibration is a reciprocating rotation motion which takes the first axis of the motor shaft as a rotation axis, and the motor shaft swings by one random angle leftwards at the high speed and then immediately swings by one random angle rightwards at the high speed.

In one or more embodiments of the specification, the driving unit includes a driving shaft connected with the cleaning head 102;

as the second cleaning motion, the driving shaft is controlled to rotate by the second random cleaning angle or the second pseudo-random cleaning angle in a first direction or a second direction with a second axis as a rotation center line relative to a reference position of the driving shaft, so as to drive the cleaning head 102 to perform a sweeping operation.

The second axis can be understood as a center point or a center axis of the second cleaning motion, and during the execution of the second cleaning motion, the driving shaft is controlled to rotate in the first direction or the second direction by the second random cleaning angle or the second pseudo-random cleaning angle with the second axis as the rotation center line, so as to drive the cleaning head 102 to perform the sweeping operation.

For example, after the electric toothbrush is started, a reference position of the motor shaft set in a factory is required to be read, the motor shaft is controlled to generate a larger-angle left-right swing (for example, greater than 10 degrees and less than 60 degrees) through a second random angle relative to the reference position, the swing is a reciprocating rotation motion taking the second axis of the motor shaft as a rotation axis, and the motor shaft swings by one random angle leftwards at the high speed and then immediately swings by one random angle rightwards at the high speed, and speed-settable random sweeping is realized, such that the electric toothbrush also maintains the vibration during sweeping, thus integrating the sweeping and the vibration.

It should be noted that after a complete periodic cleaning motion of the oral cleaning device, the driving shaft returns to the reference position for a next cleaning motion.

In one or more embodiments of the specification, the first axis is parallel to or overlapped with the second axis; or the first axis and/or the second axis are parallel to or overlapped with the axis of the driving shaft, thereby ensuring that the vibration operation and the sweeping operation can be carried out cooperatively, and avoiding a large deviation of the vibration operation and the sweeping operation.

In one or more embodiments of the specification, a control unit is mounted in the grip portion 104;

the control unit is configured to, in response to the acquired starting or adjusting signal, determine the reference position of the driving shaft in the driving unit, generate the target driving signal based on the reference position and the random cleaning angle, and send the target driving signal to the driving unit;

the random cleaning angle is generated by the control unit based on a random angle generation algorithm.

The random angle generation algorithm may be set according to an actual application scenario; for example, the random angle generation algorithm may be a pseudo-random number generator, a Gaussian distribution random number, or an algorithm written in a programming language.

According to the above embodiment, after the electric toothbrush is started, the control unit in the electric toothbrush determines the reference position of the driving shaft in the driving unit, generates the random cleaning angle using the random angle generation algorithm, then generates the target driving signal based on the reference position and the random cleaning angle, and sends the target driving signal to the motor, so as to control the motor to run, thereby executing the oral cleaning operation and meeting an oral cleaning requirement of the user.

In one or more embodiments of the specification, the control unit is further configured to:
receive a reference position setting signal for the driving shaft sent by a device control terminal or an input terminal, and control the driving unit to stop driving, the device control terminal being connected with the oral cleaning device through a wireless signal or the input terminal being electrically connected with the control unit; and
rotate the driving shaft to a target position, receive a reference position confirmation signal for the driving shaft sent by the device control terminal or the input terminal, and determine a current position of the driving shaft as the reference position.

The input terminal may be understood as a component for inputting the reference position setting signal for the control unit, and the input terminal may be a control button, a touch screen, or the like.

The reference position setting signal may be understood as a signal for indicating that the control unit sets the reference position of the driving shaft; for example, the reference position setting signal may be a reference position reset signal or a reference position update signal.

Rotating the driving shaft to the target position may be understood as rotating the driving shaft to the target position under an external force, or controlling the driving unit to rotate the driving shaft to the target position; the target position may be set according to an actual application scenario; for example, the target position may refer to a position where a cleaning surface of the cleaning head 102 faces the user or the cleaning surface of the cleaning head 102 is in the same plane as the user interaction control 106.

The reference position confirmation signal may be understood as a signal for indicating that the control unit rotates the driving shaft to the target position relative to the reference position of the driving shaft.

In one or more embodiments of the specification, the reference position of the driving shaft includes a position of the driving shaft when the driving shaft is rotated under control of an external force to bring the cleaning surface of the cleaning head 102 to be in the same plane as the user interaction control 106 in the grip portion 104; or

the reference position of the driving shaft includes a position of the driving shaft before the oral cleaning operation is determined to be performed.

The cleaning surface may be understood as a surface of the cleaning head 102 which contacts the to-be-cleaned oral region and is configured to clean the to-be-cleaned oral region; for example, the cleaning surface may be a bristle surface of the brush head.

The user interaction control 106 may be understood as a control provided in the oral cleaning device and configured to interact with the user; for example, the user interaction control 106 may be one or more components in a button, a display screen, a touch screen, a sensor, a microphone, a speaker, an indicator light, a camera, or the like, and is not limited herein.

Specifically, the reference position of the driving shaft in the oral cleaning device can be determined in two ways; first, the driving shaft is rotated by the external force, and the current position of the driving shaft is determined as the reference position of the driving shaft when the driving shaft is rotated under the control of the external force to bring the cleaning surface of the cleaning head 102 to be in the same plane as the user interaction control 106 in the grip portion 104; second, the position of the driving shaft set when the oral cleaning device leaves the factory or the position where the driving shaft stays after one complete periodic cleaning motion is used as the reference position of the driving shaft; the reference position of the driving shaft is determined in various ways, such that the oral cleaning device can be better suitable for various conditions in actual scenarios, and applicability is improved.

In one or more embodiments of the specification, the control unit is further configured to receive a position adjusting signal sent by the device control terminal and carrying the reference position, and control the driving unit to perform a position calibration operation on the driving shaft based on the reference position;

the driving unit is further configured to rotate the driving shaft to the reference position based on the control of the control unit to perform the position calibration operation.

Specifically, during the oral cleaning operation, the device control terminal may send the position adjusting signal carrying the reference position to the control unit for adjusting the reference position of the driving shaft.

After receiving the position adjusting signal, the control unit can control the driving unit to perform the position calibration operation on the current position of the driving shaft based on the reference position; the driving unit can rotate the driving shaft to the reference position under the control of the control unit to execute the position calibration operation, such that the reference position of the driving shaft is adjusted to a proper position during the oral cleaning operation to facilitate subsequent smooth oral cleaning.

In one or more embodiments of the specification, the control unit is further configured to control the driving unit to perform a position calibration operation on the driving shaft based on the reference position in the case where the performing of the oral cleaning operation is determined to be completed;

the driving unit is further configured to rotate the driving shaft to the reference position based on the control of the control unit to perform the position calibration operation.

Specifically, after the oral cleaning device performs the oral cleaning operation, the control unit may control the driving unit to return the driving shaft to the reference position for the next cleaning motion.

One or more embodiments of the specification provide an electric toothbrush, including:
a cleaning head 102 at least having a cleaning unit (for example, a brush head); a grip portion 104 connected with the cleaning head; a driving unit (for example, a motor) at least partially accommodated in the grip portion 104, the driving unit including a driving shaft (for example, a motor shaft) engaged with the cleaning head 102; and
a control assembly which drives the driving shaft of the driving unit to output a cleaning motion using a driving signal and drives the cleaning unit hereby, wherein the cleaning motion includes a first cleaning motion and a second cleaning motion, and as the first cleaning motion, the driving shaft is rotated in a first direction or a second direction by a first random cleaning angle or a first pseudo-random cleaning angle relative to a reference position thereof with a first axis as a rotation center line, and as the second cleaning motion, the driving shaft is rotated in the first direction or the second direction by a second random cleaning angle or a second pseudo-random cleaning angle relative to the reference position thereof with a second axis as the rotation center line, and the first random cleaning angle and the second random cleaning angle are different.

Further, when the cleaning unit is controlled to rotate in the first direction or the second direction by the second random cleaning angle with the second axis as the rotation center line, the driving unit has a vibration in which the driving unit rotates in the first direction or the second direction by the first random cleaning angle.

One or more embodiments of the specification provide an oral cleaning device including a grip portion, a driving unit at least partially accommodated in the grip portion, and a cleaning head connected with the driving unit; the grip portion is configured to acquire a starting or adjusting signal and send a target driving signal carrying a random cleaning angle to the driving unit, the driving unit is configured to, in response to the target driving signal, drive the cleaning head to perform a cleaning motion according to the random cleaning angle, and the cleaning head is configured to contact a to-be-cleaned oral region and perform an oral cleaning operation on the to-be-cleaned oral region based on the driving of the driving unit, such that oral cleaning is flexibly performed based on the random cleaning angle, thereby adapting to actual conditions of different to-be-nursed oral cavities, and meeting personalized oral care demands of users.

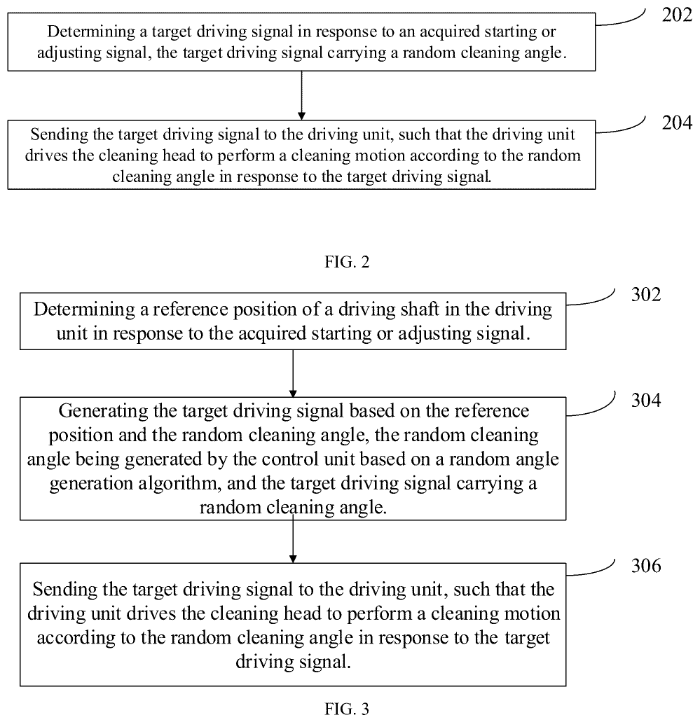

Referring to FIG. 2, FIG. 2 shows a flow chart of a control method according to an embodiment of the specification, the control method is applied to a control unit in an oral cleaning device, the oral cleaning device including a grip portion, a driving unit at least partially accommodated in the grip portion, and a cleaning head connected with the driving unit, and the control method specifically includes the following steps.

Step 202: determining a target driving signal in response to an acquired starting or adjusting signal, the target driving signal carrying a random cleaning angle.

Step 204: sending the target driving signal to the driving unit, such that the driving unit drives the cleaning head to perform a cleaning motion according to the random cleaning angle in response to the target driving signal.

For the explanation of the above steps, reference may be made to corresponding or respective contents in the above embodiment of the oral cleaning device, which are not repeated herein.

Referring to FIG. 3, FIG. 3 is a flow chart of another control method according to an embodiment of the specification, and the control method specifically includes the following steps.

Step 302: determining a reference position of a driving shaft in the driving unit in response to the acquired starting or adjusting signal.

Step 304: generating the target driving signal based on the reference position and the random cleaning angle, the random cleaning angle being generated by the control unit based on a random angle generation algorithm, and the target driving signal carrying a random cleaning angle.

Step 306: sending the target driving signal to the driving unit, such that the driving unit drives the cleaning head to perform a cleaning motion according to the random cleaning angle in response to the target driving signal.

In one or more embodiments of the specification, the target driving signal includes a first driving signal and/or a second driving signal;

the first driving signal carries a first random cleaning angle or a first pseudo-random cleaning angle, and the first driving signal is used to control the driving unit to drive the cleaning head to perform a first cleaning motion according to the first random cleaning angle or the first pseudo-random cleaning angle,

the second driving signal carries a second random cleaning angle or a second pseudo-random cleaning angle, and the second driving signal is used to control the driving unit to drive the cleaning head to perform a second cleaning motion according to the second random cleaning angle or the second pseudo-random cleaning angle.

For example, an execution mode of the above steps may be as follows: a control unit of an electric toothbrush (i.e., the oral cleaning device) determines a reference position of a motor shaft (i.e., the driving shaft) under the condition of acquiring a starting or adjusting signal, the reference position of the motor shaft can be a position which is set in a factory and allows bristles of a brush head mounted on the driving shaft to face a user, or a position where, after starting, the user controls the motor shaft of the electric toothbrush to rotate until the bristles of the brush head mounted on the driving shaft face the user, and a random cleaning angle is generated based on a random angle generation algorithm; a target driving signal is generated according to the reference position and the random cleaning angle and sent to a motor, and the motor shaft of the electric toothbrush is controlled to vibrate at the random cleaning angle or move at a random sweeping amplitude relative to the reference position, such that the brush head is driven to perform an oral cleaning operation, sweeping flexible and changeable in a certain range is provided to adapt to different conditions of to-be-cleaned oral cavities, and a cleaning effect is better.

It should be noted that the target driving signal includes a first driving signal and/or a second driving signal.

The first driving signal carries a first random cleaning angle or a first pseudo-random cleaning angle, and the first driving signal is used to control the motor to drive the motor shaft to randomly vibrate leftwards or rightwards at a high speed within a small angle range (0 to 10 degrees) relative to the reference position thereof according to the first random cleaning angle or the first pseudo-random cleaning angle, so as to drive the brush head to vibrate, and an oral region can be cleaned.

The second driving signal carries a second random cleaning angle or a second pseudo-random cleaning angle, the second driving signal is used to control the motor to drive the motor shaft to generate a larger-angle swing (for example, greater than 10 degrees and less than 60 degrees) through the second random cleaning angle or the second pseudo-random cleaning angle while keeping the vibration, and speed-settable random sweeping is realized, such that the vibration is kept during sweeping, thus integrating the sweeping and the vibration.

For the explanation of the above steps, reference may also be made to corresponding or respective contents in the above embodiment of the oral cleaning device, which are not repeated herein.

One or more embodiments of the specification provide the control method applied to the control unit in the oral cleaning device, the oral cleaning device including the grip portion, the driving unit at least partially accommodated in the grip portion, and the cleaning head connected with the driving unit; the control unit may generate the target driving signal carrying the random cleaning angle in response to the acquired starting or adjusting signal and send the target driving signal to the driving unit, the driving unit drives the cleaning head to perform the cleaning motion according to the random cleaning angle in response to the target driving signal, and the cleaning head is configured to contact the to-be-cleaned oral region and perform the oral cleaning operation on the to-be-cleaned oral region based on the driving of the driving unit, such that oral cleaning is flexibly performed based on the random cleaning angle, thereby adapting to actual conditions of different to-be-nursed oral cavities, and meeting personalized oral care demands of users.

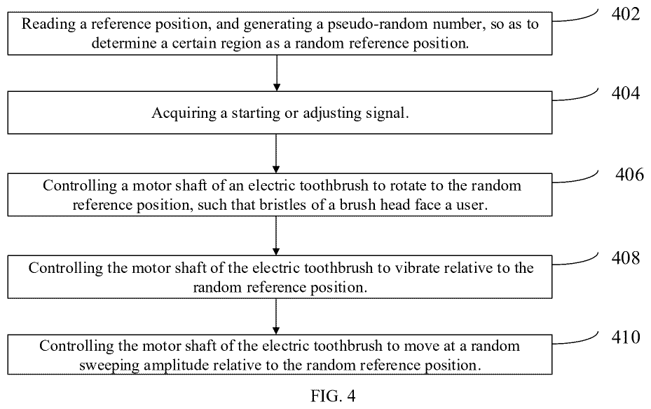

Referring to FIG. 4, the control method of the specification is further described below by taking the application of the control method in an oral cleaning scenario as an example. FIG. 4 shows a flow chart of a process of a control method according to an embodiment of the specification, which specifically includes the following steps.

Step 402: reading a reference position, and generating a pseudo-random number, so as to determine a certain region as a random reference position.

Step 404: acquiring a starting or adjusting signal.

Step 406: controlling a motor shaft of an electric toothbrush to rotate to the random reference position, such that bristles of a brush head face a user.

Step 408: controlling the motor shaft of the electric toothbrush to vibrate relative to the random reference position.

Specifically, the motor shaft is controlled to randomly swing leftwards or rightwards at a high speed within a certain small angle range (0 to 10 degrees) relative to the reference position thereof according to a first random cleaning angle, so as to realize a vibration with a changeable frequency; the vibration is a reciprocating rotation motion which takes an axis of the motor shaft as a rotation axis, and the motor shaft swings by one random angle leftwards at the high speed and then immediately swings by one random angle rightwards at the high speed; the random angle includes a reference range, and if the reference range includes left 5 degrees or right 5 degrees, under control of a random signal, the motor shaft firstly swings leftwards by 5.1 degrees and then swings rightwards by 4.9 degrees.

Step 410: controlling the motor shaft of the electric toothbrush to move at a random sweeping amplitude relative to the random reference position.

Specifically, the motor shaft is controlled to generate a larger-angle swing (for example, greater than 10 degrees and less than 60 degrees) through a second random cleaning angle while keeping the vibration, and speed-settable random sweeping is realized, such that the vibration is kept during sweeping, thus integrating the sweeping and the vibration.

Based on the above steps, with the control method applied to the electric toothbrush of the specification, the vibration flexible and changeable in a certain range is provided to adapt to different conditions of the to-be-cleaned oral cavities, the set vibration range ensures a basic cleaning force, and on the basis, more different parts can be cleaned using the randomly variable vibration angle (the motor of the electric toothbrush vibrates at a high frequency, a part of the user required to be cleaned may not be cleaned in a single randomly variable vibration, but the vibration frequency is 30,000 to −40000 per minute, and more different parts can be cleaned under multiple iterations), such that a cleaning effect is better; in addition, the sweeping flexible and changeable in a certain range is provided to adapt to different conditions of the to-be-cleaned oral cavities, and thus, the cleaning effect is better.

The foregoing is a schematic solution of the control method according to the present embodiment. It should be noted that the technical solution of the control method belongs to the same concept as the technical solution of the oral cleaning device described above, and for details not described in detail in the technical solution of the control method, reference may be made to the description of the technical solution of the oral cleaning device described above.

What is claimed is:

1. An oral cleaning device, comprising a grip portion, a driving unit at least partially accommodated in the grip portion, and a cleaning head connected with the driving unit;
wherein the grip portion is configured to acquire a starting or adjusting signal and send a target driving signal to the driving unit, the target driving signal carrying a random cleaning angle;
the driving unit is configured to, in response to the target driving signal, drive the cleaning head to perform a cleaning motion according to the random cleaning angle;
the cleaning head is configured to contact a to-be-cleaned oral region and perform an oral cleaning operation on the to-be-cleaned oral region based on the driving of the driving unit.

2. The oral cleaning device according to claim 1, wherein the target driving signal comprises a first driving signal and/or a second driving signal;
the first driving signal carries a first random cleaning angle or a first pseudo-random cleaning angle;
the driving unit is further configured to, in response to the first driving signal, drive the cleaning head to perform a first cleaning motion according to the first random cleaning angle or the first pseudo-random cleaning angle;
the second driving signal carries a second random cleaning angle or a second pseudo-random cleaning angle;
the driving unit is further configured to, in response to the second driving signal, drive the cleaning head to perform a second cleaning motion according to the second random cleaning angle or the second pseudo-random cleaning angle.

3. The oral cleaning device according to claim 2, wherein the first driving signal carries a first reference range;
the driving unit is further configured to, in response to the first driving signal, drive the cleaning head to perform the first cleaning motion according to the first random cleaning angle or the first pseudo-random cleaning angle within the first reference range.

4. The oral cleaning device according to claim 2, wherein the second driving signal carries a second reference range;
the driving unit is further configured to, in response to the second driving signal, drive the cleaning head to perform the second cleaning motion according to the second random cleaning angle or the second pseudo-random cleaning angle within the second reference range.

5. The oral cleaning device according to claim 2, wherein the driving unit comprises a driving shaft connected with the cleaning head;
as the first cleaning motion, the driving shaft is controlled to rotate by the first random cleaning angle or the first pseudo-random cleaning angle in a first direction or a second direction with a first axis as a rotation center line relative to a reference position of the driving shaft, so as to drive the cleaning head to perform a vibration operation.

6. The oral cleaning device according to claim 5, wherein the driving unit comprises the driving shaft connected with the cleaning head;
as the second cleaning motion, the driving shaft is controlled to rotate by the second random cleaning angle or the second pseudo-random cleaning angle in the first direction or the second direction with a second axis as the rotation center line relative to the reference position of the driving shaft, so as to drive the cleaning head to perform a sweeping operation.

7. The oral cleaning device according to claim 2, wherein the first random cleaning angle or the first pseudo-random cleaning angle is less than 10 degrees.

8. The oral cleaning device according to claim 2, wherein the second random cleaning angle or the second pseudo-random cleaning angle is greater than or equal to 10 degrees and less than or equal to 60 degrees.

9. The oral cleaning device according to claim 6, wherein the first axis is parallel to or overlapped with the second axis; or
the first axis and/or the second axis are parallel to or overlapped with an axis of the driving shaft.

10. The oral cleaning device according to claim 1, wherein a control unit is mounted in the grip portion;
the control unit is configured to, in response to the acquired starting or adjusting signal, determine a reference position of a driving shaft in the driving unit, generate the target driving signal based on the reference position and the random cleaning angle, and send the target driving signal to the driving unit;
the random cleaning angle is generated by the control unit based on a random angle generation algorithm.

11. The oral cleaning device according to claim 10, wherein the control unit is further configured to:
receive a reference position setting signal for the driving shaft sent by a device control terminal or an input terminal, and control the driving unit to stop driving, the device control terminal being connected with the oral cleaning device through a wireless signal or the input terminal being electrically connected with the control unit; and
rotate the driving shaft to a target position, receive a reference position confirmation signal for the driving shaft sent by the device control terminal or the input terminal, and determine a current position of the driving shaft as the reference position.

12. The oral cleaning device according to claim 10, wherein the reference position of the driving shaft comprises a position of the driving shaft when the driving shaft is rotated under control of an external force to bring a cleaning surface of the cleaning head to be in the same plane as user interaction control in the grip portion; or
the reference position of the driving shaft comprises a position of the driving shaft before the oral cleaning operation is determined to be performed.

13. The oral cleaning device according to claim 10, wherein the control unit is further configured to receive a position adjusting signal sent by the device control terminal and carrying the reference position, and control the driving unit to perform a position calibration operation on the driving shaft based on the reference position;
the driving unit is further configured to rotate the driving shaft to the reference position based on the control of the control unit to perform the position calibration operation.

14. The oral cleaning device according to claim 10, wherein the control unit is further configured to control the driving unit to perform a position calibration operation on the driving shaft based on the reference position in the case where the performing of the oral cleaning operation is determined to be completed;
the driving unit is further configured to rotate the driving shaft to the reference position based on the control of the control unit to perform the position calibration operation.

15. The oral cleaning device according to claim 6, wherein as the vibration operation, the cleaning head is driven to vibrate according to a preset vibration frequency range, and the preset vibration frequency range is greater than or equal to 100 Hz and less than or equal to 700 Hz;
as the sweeping operation, the cleaning head is driven to sweep according to a preset sweeping frequency range, and the preset sweeping frequency range is greater than or equal to 20 degrees per second and less than or equal to 2,000 degrees per second.

16. The oral cleaning device according to claim 1, wherein the oral cleaning device is an electric toothbrush, and the cleaning head is a cleaning brush head.

17. A control method applied to a control unit in an oral cleaning device, the oral cleaning device comprising a grip portion, a driving unit at least partially accommodated in the grip portion, and a cleaning head connected with the driving unit, the control method comprising:
determining a target driving signal in response to an acquired starting or adjusting signal, the target driving signal carrying a random cleaning angle; and
sending the target driving signal to the driving unit, such that the driving unit drives the cleaning head to perform a cleaning motion according to the random cleaning angle in response to the target driving signal.

18. The control method according to claim 17, wherein the determining a target driving signal in response to an acquired starting or adjusting signal further comprises:
determining a reference position of a driving shaft in the driving unit in response to the acquired starting or adjusting signal; and
generating the target driving signal based on the reference position and the random cleaning angle, the random cleaning angle being generated by the control unit based on a random angle generation algorithm.

19. The control method according to claim 17, wherein the target driving signal comprises a first driving signal and/or a second driving signal,
the first driving signal carries a first random cleaning angle or a first pseudo-random cleaning angle,
the first driving signal is used to control the driving unit to drive the cleaning head to perform a first cleaning motion according to the first random cleaning angle or the first pseudo-random cleaning angle,
the second driving signal carries a second random cleaning angle or a second pseudo-random cleaning angle,
the second driving signal is used to control the driving unit to drive the cleaning head to perform a second cleaning motion according to the second random cleaning angle or the second pseudo-random cleaning angle.

20. A computing device, comprising:
a memory and a processor;
wherein the memory is configured to store a computer program/instruction, the processor is configured to execute the computer program/instruction, and the computer program/instruction, when executed by the processor, implements the steps of the control method according to claim 17.
